(19) United States
(12) Patent Application Publication
(10) Pub. No.: US 2009/0225546 A1
(43) Pub. Date: Sep. 10, 2009

(54) Modular LED Lighting Fixtures

(76) Inventors: Dennis Pearson, Foothill Ranch, CA (US); Terry Horwitz, Garden Grove, CA (US); Richard Horvath, Mission Viejo, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/130,882

(22) Filed: May 30, 2008

Related U.S. Application Data
(60) Provisional application No. 61/033,654, filed on Mar. 4, 2008.

(51) Int. Cl. F21S 4/00; F21V 21/00

(52) U.S. Cl. 362/249.06

(57) ABSTRACT

Concatenatable lighting fixtures, each comprising a unitary cover member having a circuit board mounting platform integrally formed with suitable heat sinking and which cover member mounts onto a cooperating base chassis. In one embodiment, the circuit board mounting platform extends farther from one end of the cover member than the other so as to facilitate placement of LEDs in a fashion which enhances lighting uniformity and minimizes dark spots. First and second guide members may be positioned in respective opposite ends of adjacent fixtures, each guide member having a plurality of extending fingers with a flexible electrical conductor-carrying conduit disposed between the respective opposite ends and retained in position by said fingers.

This application claims the Paris Convention priority of U.S. Provisional Application No. 61/033,654 entitled “Modular LED Lighting Fixtures,” filed Mar. 4, 2008, the contents of which are hereby incorporated by reference in their entirety.

### BACKGROUND OF THE INVENTION

1. Field of Invention

This invention relates to the field of lighting technology and more specifically, to the use of LEDs in commercial and residential lighting fixtures.

2. Description of Related Art

Incandescent lighting has a low efficiency since much of the electrical power supplied to such lighting is converted to heat instead of light. The cost of electricity is expected to increase in the future as the cost of producing electricity rises. LEDs (light emitting diodes) provide a much more efficient conversion of electrical energy from incandescent lighting and efforts are underway to employ more efficient and longer lasting LED lamps in various applications.

### SUMMARY

Embodiments hereafter disclosed provide a set of interconnected, modular LED lighting fixture components that can be arranged and easily installed in the field in a wide variety of forms and shapes to meet the needs of designers and architects. Various embodiments facilitate low cost, yet attractive designs using LED lighting fixtures suitable, for example, for cove lighting applications and readily installed in the field due to various features. One such feature is a field-installable unitary cover member having a circuit board mounting platform integrally formed with suitable heat sinking and which mounts onto a cooperating base chassis. In one embodiment, the circuit board mounting platform extends farther from one end of the cover member than the other so as to facilitate placement of LEDs in a fashion to maintain relatively uniform spacing of the LED lamps, thereby enhancing lighting uniformity and minimizing dark spots. Various combinations and adaptations of such features in various embodiments facilitate practical use of energy efficient, high power LED lighting technology at modest cost in attractive and easily field installed configurations for architects and designers.

### BRIEF DESCRIPTION OF THE DRAWINGS

The foregoing, and other features and advantages, will be apparent from the following, more particular description of the preferred embodiments of the invention made in conjunction with the accompanying drawings of which:

FIG. 1 illustrates a frontal perspective view of two lighting fixture components interconnected together into an assembly;

FIG. 2 shows a rear perspective view of the same assembly of two components of FIG. 1;

FIG. 3 is a top view of the two components of FIG. 1;

FIG. 4 is a bottom view of the two components of FIG. 1;

FIG. 5 is a perspective view of an electrical wiring conduit guide;

FIG. 6 is a perspective view of the two fixture components of FIG. 1 with one component cut away to illustrate internal features;

FIG. 7 is an exploded perspective view of an alternate embodiment;

FIG. 8 is an exploded perspective view of a second alternate embodiment;

FIG. 9 is an exploded perspective view of a third alternate embodiment;

FIG. 10 is an exploded perspective view of a fourth alternate fixture component embodiment;

FIG. 11 is a top view of two fixture components according to the embodiment of FIG. 10 joined together;

FIG. 12 is a bottom view of the apparatus of FIG. 11; and

FIG. 13 is a perspective view of a cover component of the embodiment of FIG. 10.

FIGS. 14 and 15 are schematic diagrams illustrating LED lamp placement according to two respective illustrative embodiments.

### DETAILED DESCRIPTION OF EMBODIMENTS

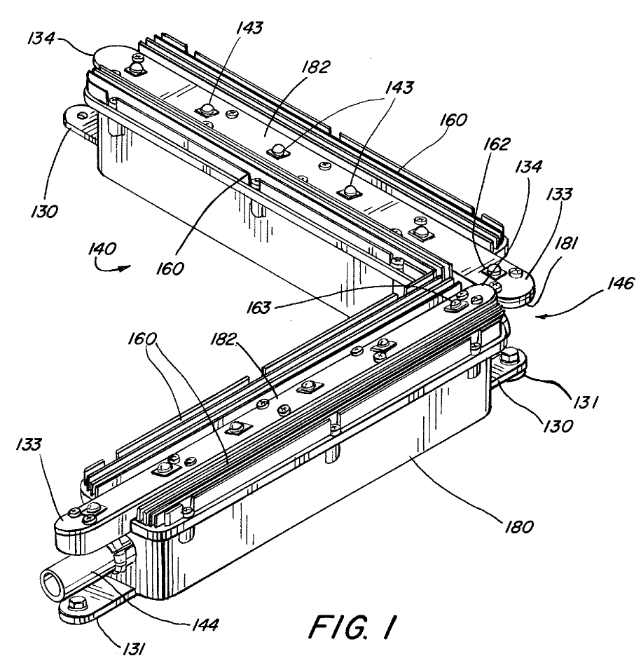

Further features and advantages, as well as the structure and operation of various embodiments are described in detail below with reference to the accompanying FIGS. 1-8, wherein like reference numerals refer to like elements. The embodiments are described in the context of several component designs with compatible electrical connectors and localized heat sinks. Nonetheless, one of ordinary skill in the art will readily recognize that other embodiments can use different forms and shapes, with different electrical connectors and other features.

FIGS. 1-6 illustrate two generally elongated, box-shaped fixture components 140 and 180 which can be joined at selected arbitrary angles with respect to one another to provide highly configurable LED lighting arrangements. Each fixture component 140, 180, contains a plurality of LED light emitting diodes 143, with suitable heat sinking, e.g. 160. The heat sink component 160, as shown in FIG. 1, for example, is a unitary component bolted or otherwise fastened along its edges to the sides of each component 140, 180. A printed circuit board 182 to which the LEDs 143 are mounted is then attached to the heat sink by suitable screws or other fastening devices or, in other embodiments, a suitable heat transfer adhesive.

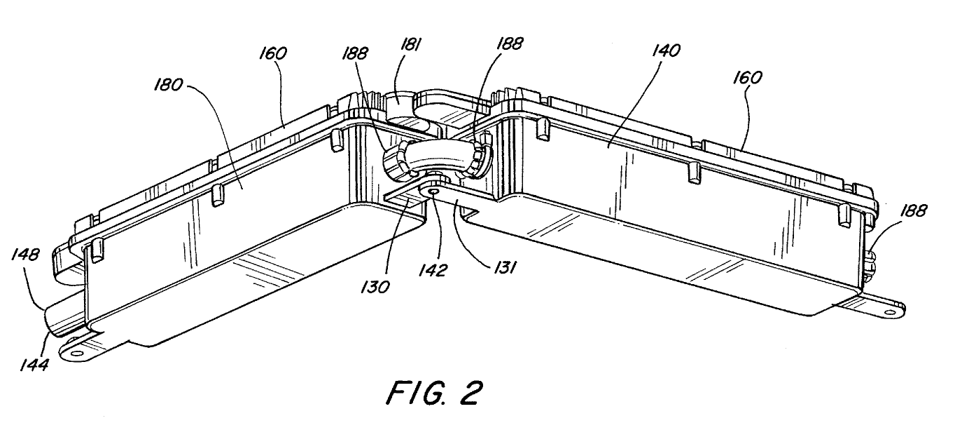

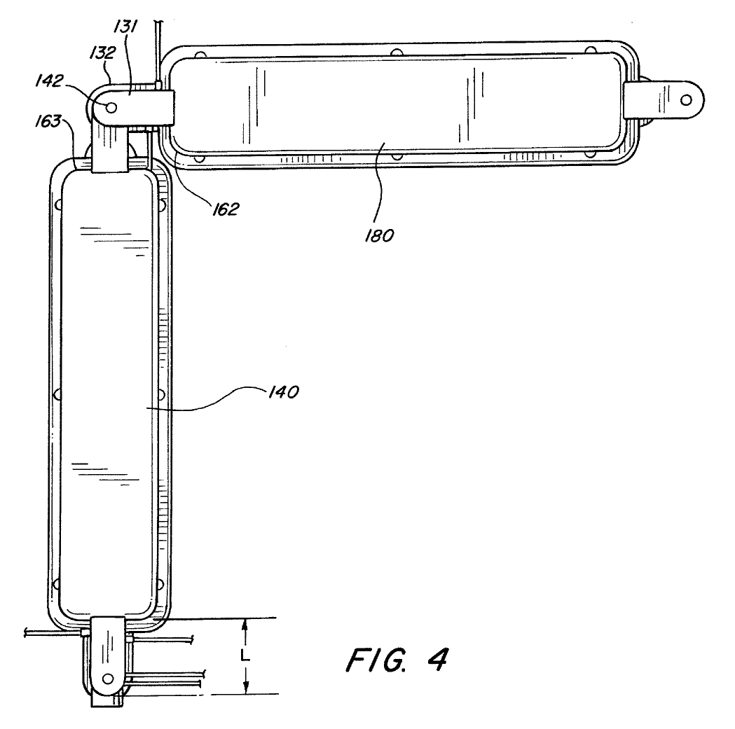

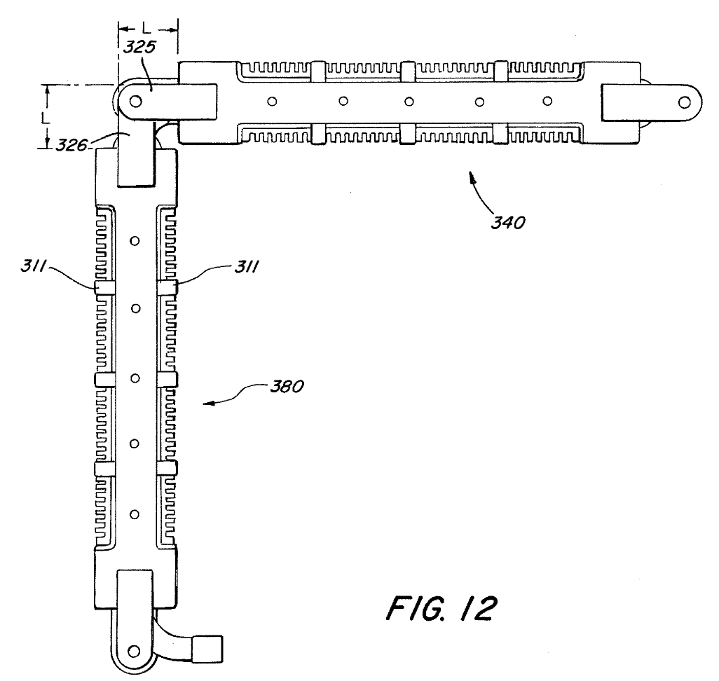

An elbow joint 146 is formed when the two components 140, 180 are joined by attaching a lower tongue 130 of one component 140 to a lower tongue 131 of the other component 180. As shown in FIGS. 4 and 12, these lower tongues 130, 131 each extend the same length “L” from the respective edges, e.g. 162, 163 of the mating components 140, 180. As may be seen in FIG. 2, the lower tongue 131 of the first fixture component 140 extends so as to underlie the mating lower tongue 130, and these two tongues are attached together by a bolt, screw, or other mechanism 142. Alternatively, a snap-fit pivot interconnection mechanism may be provided to interconnect the two lower tongues 130,131.

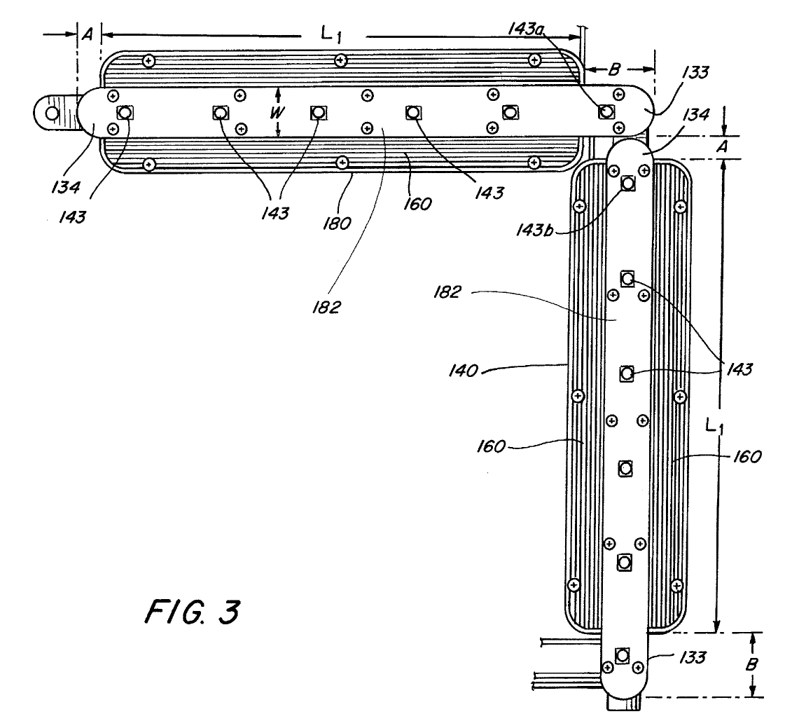

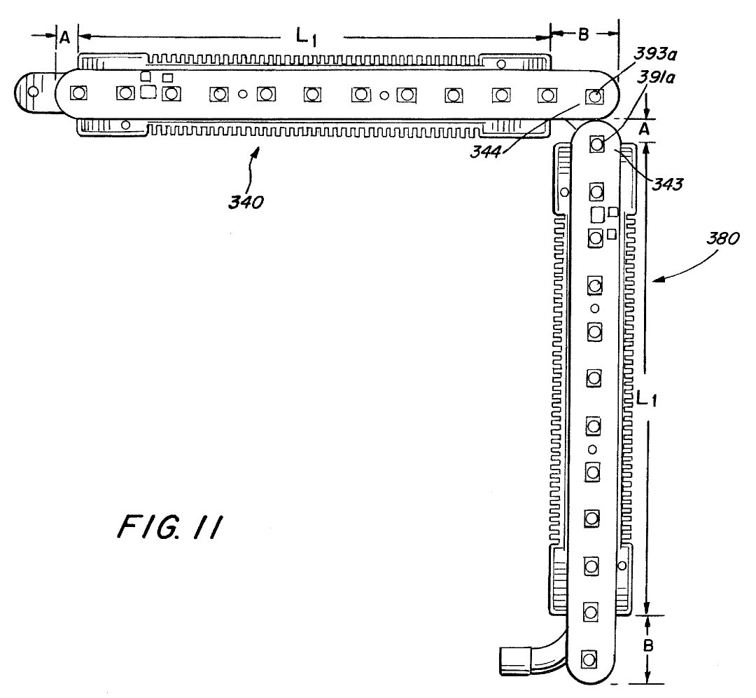

Each component 140, 180 further has a circuit board mounting platform 181, which extends beyond the length of the box-shaped portion of the component at each end. A circuit board 182, which, in the illustrative embodiment, has the same shape as the platform 181, is mounted on top of the platform 181, and has respective tongues 133, 134 at each end thereof. As illustrated in FIGS. 3 and 11, the extended length “A” of one of the tongues 134 of each circuit board 182 is selected to be equal to half of the width (½ “W”) of the circuit board 182, while the extended length “B” of the opposite tongue 133 is selected to be equal to one and a half times the width ( 3/2 “W”) of the particular circuit board 182. The distance “L₁” between the two extended lengths A, B is preferably the same for each of the circuit boards 182. Thus, tongue 134 is shorter than tongue 133. These different lengths allow the two components 140, 180 to be joined at an arbitrary angle with respect to one another of between, for example, −90 degrees and +90 degrees, while still maintaining the LED's of each of the components e.g. LED's 143a, 143b, spaced close enough together to enhance the uniformity of illumination and to eliminate or considerably reduce the effects of dark spots, or so-called “scalloping”. While 90 degree bends are illustrated in the figures, 20 to 30 degree bends are more common in practice. In other embodiments, the extended lengths “A”, “B”, may be shorter or longer.

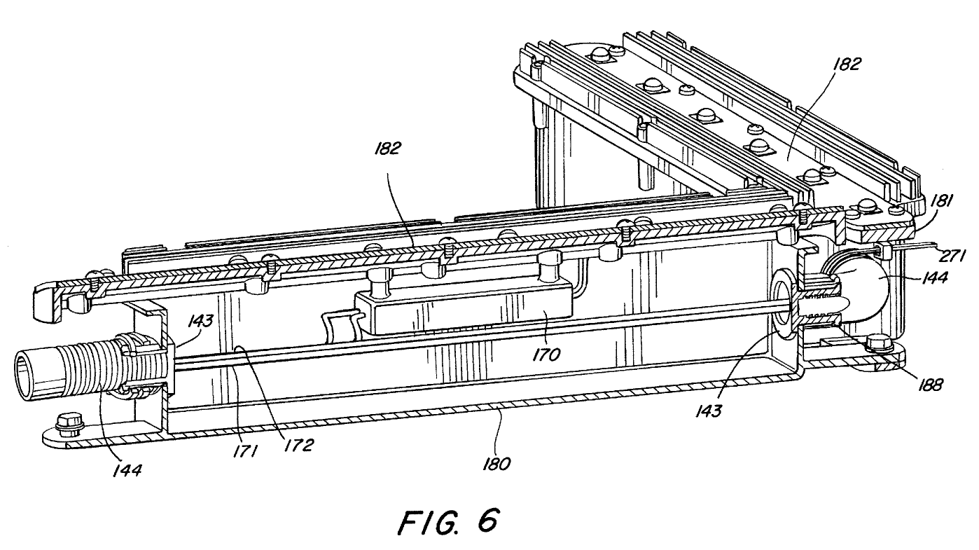

To facilitate passage of electrical conductors between the two components 140, 180, the elbow joint 146 includes a non-conductive flexible conduit 144 disposed between them. The conduit 144 provides a hollow tube through which current carrying wires, e.g. 171, 172 supplying a lamp driver unit 170 (FIG. 6) are passed. The conduit 144 passes through and is maintained in position by first and second tubular nonconductive guides 188 and 148 and a tie wrap fastener 271 (e.g. FIG. 2). The conduit 144 may be fabricated using Part No. SM-1216-HY tubing available from Sealcon Co.

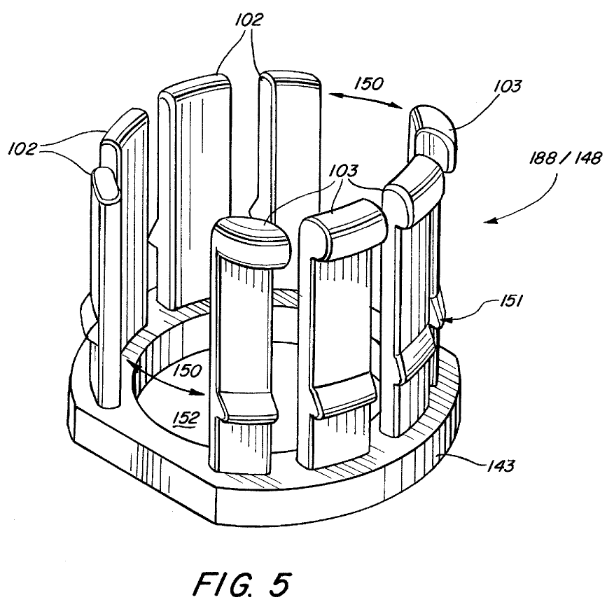

FIG. 5 illustrates one of the non conductive guides 188, preferably formed of a suitable plastic, which support and guide the electrical wiring conduit 144, allowing the assembly's elbow joint 146 to bend through a range of angles. The conductive guide 188 includes a base 143 having a circular opening 152 therein and from which projects two sets 102,103 of perpendicularly disposed and radically positioned fingers, which provide a bushing for supporting the conduit 144. There are respective gaps 150 between the sets of fingers 102, 103, which enable them to flex toward one another so as to firmly grasp a conduit section 144 when the tie wrap fastener 271 (e.g. FIG. 2) is applied. Each of the fingers 102, 103 may have a lip or bulbous projection 109 formed on the outer surface of their respective ends 107, 108 to assist in retaining the tie wrap 271 in position. Nubs 145 are also provided on the outer surfaces of each of the fingers 102, 103 to further assist in positioning the tie wrap fastener 271.

As may be seen in FIG. 6, the base 143 of the guide 188 abuts an inner end surface 173 of a fixture component while the fingers 102,103 extend to capture a respective end of the flexible conduit 144, which may then be fastened in place by a tie wrap fastener, e.g. 271.

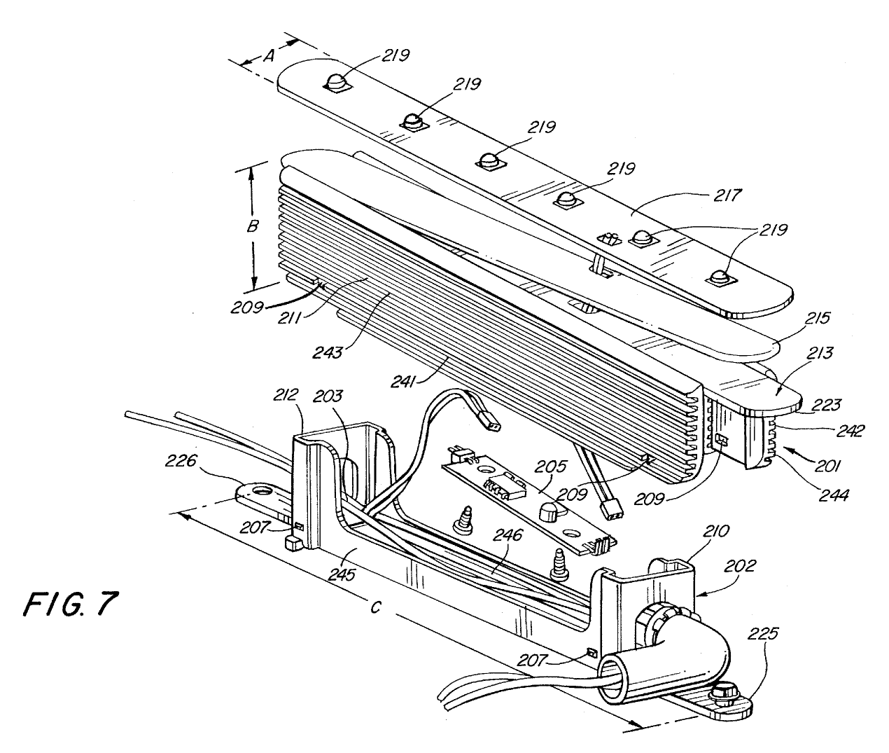

FIG. 7 illustrates another embodiment wherein a unitary cover member 201 is adapted to snap onto a base 202 to form an enclosure for wiring 203 and an LED electrical driver circuit board 205 and attached componentry. The cover member 201 has generally rectangular parallel elongated sides 241, 242, which may be mirror images of one another and which include an array of horizontally veined heat sink fins 243, 244.

The snap-on mechanism may be achieved by providing suitable tabs, tangs, or lips 207 positioned on the side of the base unit 202 so as to mate with apertures 209 in the cover member 201. In such an embodiment, the cover member 201 may exhibit elasticity to flex along its width sufficient to snap over and engage the tangs 207 on the base unit 202, providing the advantage of being able to snap the base 202 and cover 201 together during installation in the field. As shown in FIG. 7, the tabs 207 are formed on respective upwardly projecting end posts 210, 212, which are joined by parallel side rails 245, 246, all integrally formed as part of the preferably unitary base or chassis 202.

Both the base 202 and cover 201 may be formed of die cast aluminum or other suitable metals or composites. The metals may include topical treatments to aid in heat dissipation such as anodizing, paints or other treatments that facilitate heat dissipation. Thermal plastics with metallic based fillers that aid in heat dissipation may be used. A mechanical fastener or fasteners such as screws or a mechanical snap device may also be used to hold the PC board in place onto the heat dissipating cover instead of thermal tape. The thermal tape (such as Berquest, 401 or 3M equivalent) acts to hold the PC board in place without mechanical fasteners and facilitates the transfer of heat to the heat dissipating cover. The alternative use of any coating or topical treatment such as grease, paste or oil that aids in dissipating heat from the PC Board to the heat dissipating base can be used. Illustrative dimensions for a fixture unit as shown in FIG. 7 are circuit board width A′=1 inch, housing height B′=1.5 inches, and base length from one attachment hole center line to the other C′=12 inches or 6 inches.

As may be further seen in FIG. 7, the cover member 201 includes an elongated platform 213, which provides a mounting surface for a conformingly shaped thermal adhesive tape strip 215 and overlying circuit board 217, which carries a serial array of LED's 219. The tape 215 serves to attach the circuit board 217 to the platform 213, while transferring heat from the LED's 219 to the heat sink arrangement 211. Sufficient heat sinking is provided to remove the heat expected to be generated by the LEDs 219 based on their particular power (driving) requirements. Other means of attaching the circuit board 217 may be used, such as for example, rivets or threaded devices such as screws.

The platform 213 of the cover member 201 further has respective radiused tongues 223, 224 at its opposite ends, whose respective lengths differ and are preferably selected as discussed above in connection with the embodiment of FIGS. 1-6 so as to facilitate the positioning of LEDs 219 in adjacent, interconnected units so as to enhance the uniformity of illumination and avoid dark spots. Similarly, lower tongues 225, 226 extend from the base member and are dimensioned so as to facilitate attachment to adjacent units, also as discussed above.

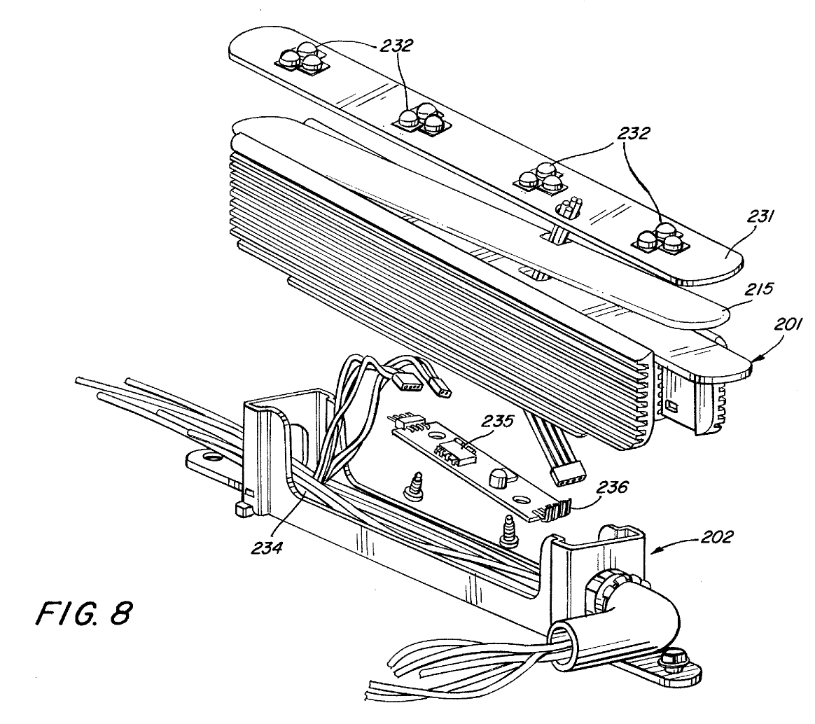

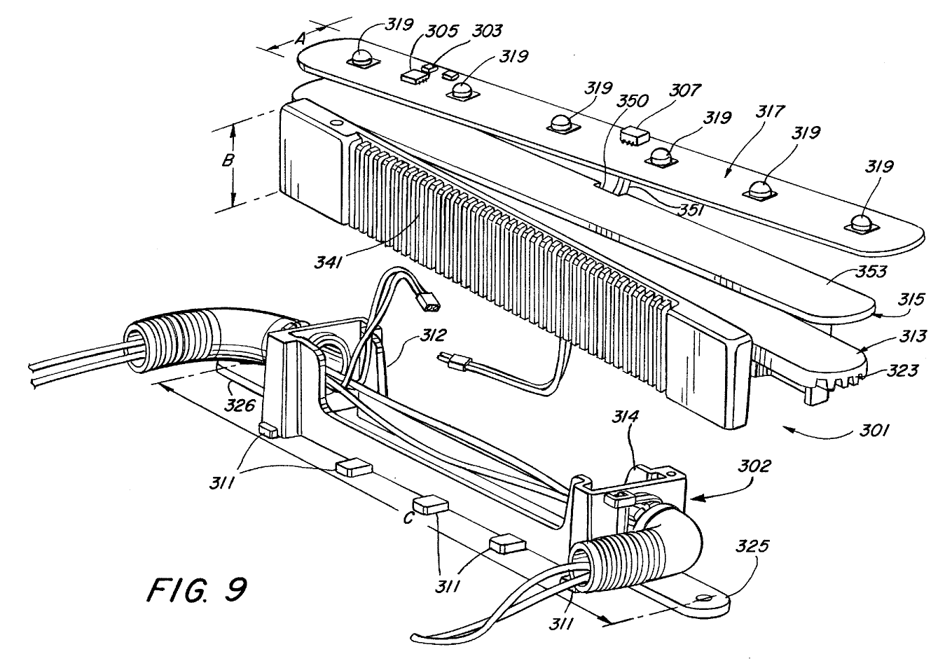

FIG. 8 illustrates an embodiment similar to that of FIG. 9. One particular difference is that the circuit board 231 of FIG. 8 carries an array of groups 232 of three LED's. Each group includes a red, green and blue LED, thus facilitating generation of various colors of light. A suitable electrical conductor arrangement 234 is additionally provided to supply current to the respective LED drivers circuitry, e.g. 235, located on internally positioned driver circuit board 236.

FIG. 9 illustrates a fixture component embodiment similar to that of FIG. 7 but with some differences. In particular, the heat sink fins e.g. 341, are disposed vertically on either side of the cover member 301, and the driver circuitry e.g. 303, 305 for the LEDs 319 is disposed on the top LED-carrying surface of the PC board 317. The PC board 317 may be fabricated of aluminum to further assist in heat transfer. Finally, the base or chassis 314, 302 has horizontally disposed feet 311 projecting perpendicularly from the side rail 345 and posts 314 on each side of the unit. In an illustrative embodiment, such feet may be ¼″ long each and extend ⅛″ from the edge of the overhanging cover member 301. These feet 311 serve to maintain proper spacing from the side of a cove wherein the fixture components, e.g. 301, may be mounted to facilitate downward installation of the cover member onto and over the chassis 302 by installers in the field and to contribute, in various applications, to better light uniformity, elimination of so-called “hot spots”, and improved thermal convection and heat dissipation. In some embodiments, holes could be provided in the feet to facilitate attachment of the unit in upright or inverted positions.

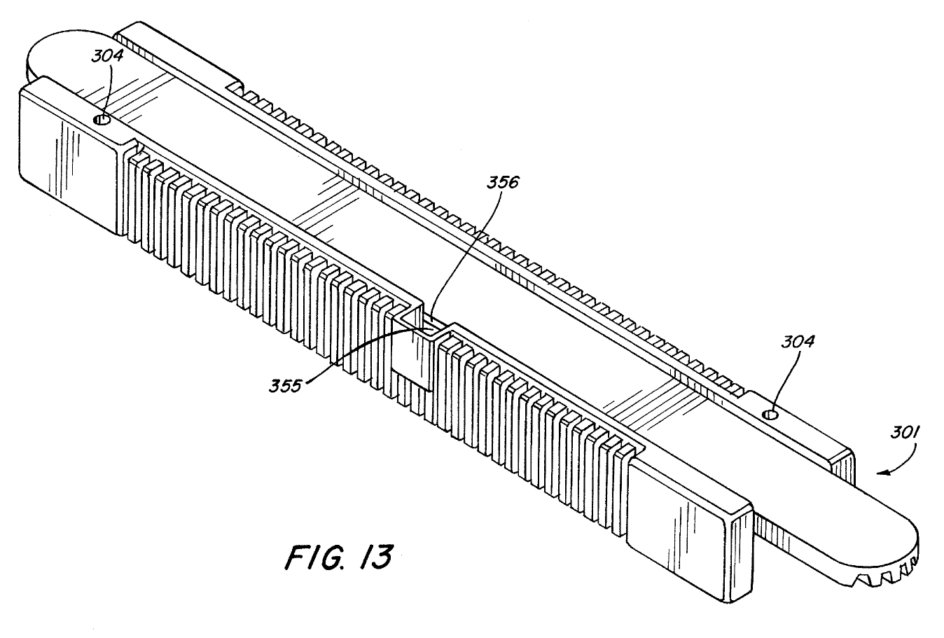

Additionally, in the embodiment of FIG. 9, the cover member 301 is attached to the chassis 302 by bolts, screws or other suitable mechanically fasteners (not shown) inserted for example, through holes 304 (FIG. 13) rather than by a snap-fit mechanism. In one embodiment, the cover 301 itself may be slightly tapered in inside cross-section such that it is slightly narrower at the bottom (dimension “D”) than at the top.

Additionally, in FIG. 9, the aperture 350 in the circuit board 315 and cooperating aperture 355 in the cover 301 for introducing electrical leads 351 may be located at an outer edge 353, 356 (FIG. 13) of the respective components 315, 301 rather than the center (e.g. FIG. 7) or other position so as to enable the circuit board to be assembled first prior to attachment of the electrical connections and to simplify cutting of the circuit board out of aluminum. Thus, the electrical wiring may curve up and over the edge of the PC board, such that it is not necessary to provide a notch or other opening in the PC board.

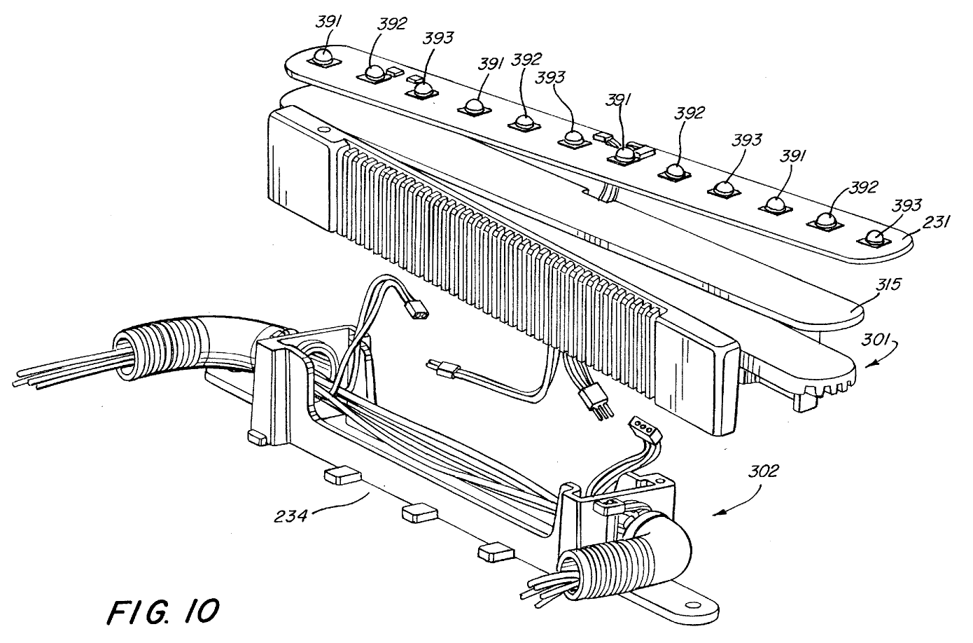

FIG. 10-12 illustrate an alternative embodiment similar to that of FIG. 9 with the exception that red, green, and blue LEDs 391, 392, 393, respectively, are employed with suitable electrical conductors and driving circuitry. As shown in FIG. 11, the A, B dimensioning of opposed tongues used in connection with the embodiment of FIGS. 1-6 is utilized to more closely position the end-most LEDs 393a, 391a of adjacent fixtures 340, 380.

Various modifications may of course be made to the above disclosed embodiments in various other embodiments. For example, the plurality of LED light emitting diodes 143 is could be directly mounted on a heat sink in one embodiment. In another embodiment, the plurality of LED light emitting diodes 143 is mounted on a series of interchangeable circuit boards fixture. A plurality of interchangeable circuit boards offers various power ratings and brightness ratings, and each fixture has an associated heat exchange requirement for various application settings and designs.

The heat sink 160, in one embodiment, has a fixed heat exchange capability in ambient air. Other embodiments may provide a range of heat sink size choices so that higher power and lower power LED light emitting diodes can be substituted to customize the design and the environment in which the components will be applied.

Various embodiments can prove advantageous in cove lighting applications where they can be concatenated and arranged to traverse various circuitous paths. In one embodiment, an oval design can be configured by choosing the proper component types and quantities to complete the oval shape as specified in particular lighting design requirements. Various embodiments may further include the advantageous wire harness interconnection and/or retention apparatus disclosed in U.S. provisional patent application Ser. No. 61/033,346, filed Mar. 3, 2008, incorporated in its entirety by reference herein.

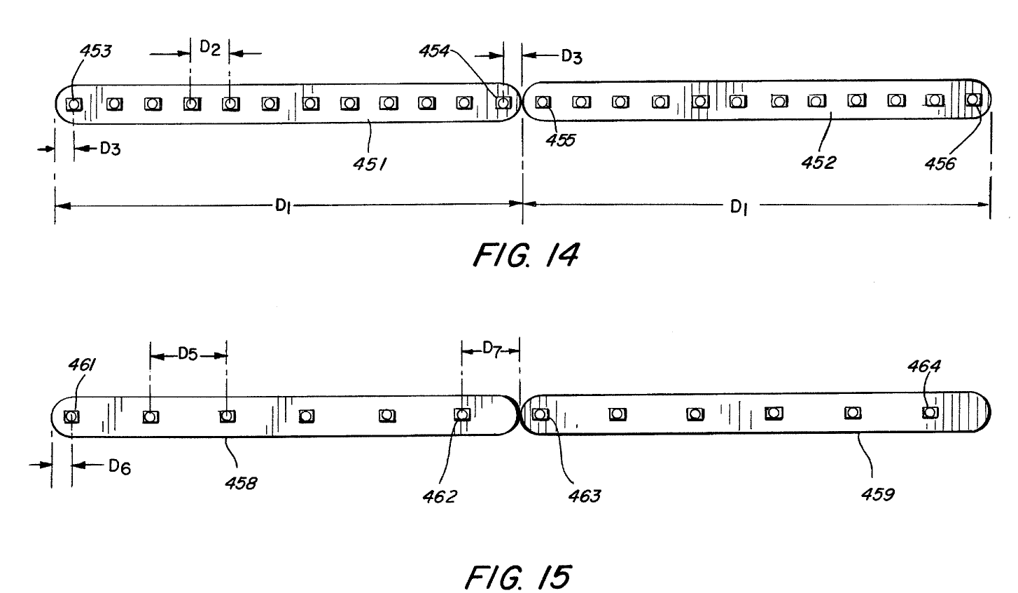

FIGS. 14 and 15 illustrate useful LED spacings which may be implemented in various embodiments. FIG. 14 illustrates two adjacent 12″ (“D₁”) PC boards 451, 452, each carrying 12 LED lamps equally spaced a distance D₂ of one inch apart from one another. The end-most LED's 453, 454, 455, 456 are each spaced a distance e.g. D₃ of ½ inch from the adjacent end of the respective board 451, 452 such that the opposite end-most lamps 454, 455 on adjacent boards 451,452 lie one inch apart, thus maintaining a one inch spacing across interconnected lamp fixture components.

FIG. 15 illustrates a layout of LED lamps spaced a distance D₅ of two inches apart on adjacent 12 inch boards 458, 459. Each board 458, 459 carries six LED lamps. The end-most lamps 461, 463 at the left end of each board 458, 459 is mounted a distance D₆ of ½ inch from that end, while the end-most lamps 462, 464 at the right-most ends are mounted a distance D₇ of 1.5 inches from those ends, thus resulting in the desired two inch spacing between the opposite end-most lamps 462, 463.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. Apparatus comprising:
a first fixture component and a second fixture component;
a first tongue extending from the first fixture component and having a length;
a second tongue extending from the second fixture component and having a length, the first and second tongues being dimensioned to overlap one another to facilitate interconnection of said first and second components;
a first mounting surface on said first component having parallel edges and terminating in a third tongue having a length;
a second mounting surface on said second component having parallel edges and terminating in a fourth tongue having a length;
first and second circuit boards positioned above said first and second mounting surfaces respectively, said first and second circuit boards each carrying a plurality of LEDs; and
the length of said third tongue being selected to be longer than the length of said fourth tongue so as to enable said first and second fixture components to be mounted at any one of a selected range of angles with respect to one another while positioning said LEDs so as to enhance uniformity of illumination provided thereby.

2. The apparatus of claim 1 further comprising:
first and second guide members positioned in respective opposite ends of said first and second components, each guide member having a plurality of extending fingers; and
a flexible conduit disposed between said respective opposite ends and retained in position by said fingers.

3. The apparatus of claim 1 wherein said first and second fixture components each comprises a unitary cover member adapted to mount onto an underlying base unit.

4. The apparatus of claim 3 wherein said cover member includes an array of heat sink fins.

5. The apparatus of claim 4 wherein said first mounting surface is formed as part of the unitary cover member of said first fixture component and said second mounting surface is formed as part of the unitary cover member of said second fixture component.

6. The apparatus of claim 5 wherein said first tongue is formed as part of the base unit of said first fixture component and said second tongue is formed as part of the base unit of said second fixture component.

7. The apparatus of claim 3 wherein an underlying base unit has a plurality of feet horizontally extending therefrom.

8. The apparatus of claim 1 wherein said first and second circuit boards are attached to said first and second mounting surfaces by thermally conductive tape.

9. The apparatus of claim 8 wherein said cover member has an aperture at an outer edge of said mounting surface providing a passageway for one or more electrical conductors.

10. Light fixture apparatus comprising:
a unitary cover member having an elongated platform, said platform providing a mounting surface for supporting a circuit board mounting an array of LEDs; and
first and second tongues extending from opposite ends of said cover member, respectively, the length of said first and second tongues being different and selected to assist in disposing said LEDs so as to enhance the uniformity of illumination provided thereby.

11. The apparatus fixture of claim 10 further comprising a unitary base member having first and second vertical support members extending upwardly therefrom, said unitary cover member fitting down and over said support members.

12. The apparatus of claim 11 wherein said cover member snap-fittingly engages said base member.

13. The apparatus of claim 11 wherein said cover member is fastened to said base member by one or more mechanical fastening devices.

14. The apparatus of claim 10 wherein one of the tongues has a length ½ W and the other tongue has a length 3/2 W where “W” is a width of said circuit board.
